(19) United States
(12) Patent Application Publication
(10) Pub. No.: US 2025/0289275 A1
(43) Pub. Date: Sep. 18, 2025

(54) Winch Connecting Device

(71) Applicant: Michael Brent Haddican, Kansas City, KS (US)

(72) Inventor: Michael Brent Haddican, Kansas City, KS (US)

(21) Appl. No.: 19/079,196

(22) Filed: Mar. 13, 2025

Related U.S. Application Data
(60) Provisional application No. 63/564,867, filed on Mar. 13, 2024.

(51) Int. Cl. B60D 1/14; B60D 1/06

(52) U.S. Cl. CPC B60D 1/143; B60D 1/06

(57) ABSTRACT

The winch connecting device is a device that allows users to connect a winch directly to a bumper hitch ball of a vehicle via a winch plate or cradle. In order to accomplish this the device includes a plurality of support brackets, a main bar, a winch receiver, and a hitch ball receiver. Further, a plurality of fasteners and a plurality of length-adjusting holes on the main bar help connect the support brackets in place and adjust the length of the main bar as needed. The main bar helps connect the external winch to the external vehicle hitch, and the hitch ball receiver connects to a hitch ball. Furthermore, one or more telescopic segments integrated within the main bar helps with length adjustments as needed. Thus, the winch connecting device is a simple and efficient device that allows a winch to be connected to a bumper hitch of a vehicle.

The current application claims a priority to the U.S. provisional patent application Ser. No. 63/564,867 filed on Mar. 13, 2024.

### FIELD OF THE INVENTION

The present invention relates generally to a device that allows a winch to connect to a hitch of a vehicle. More specifically, the present invention is a device that allows cargo vehicles to be loaded onto a trailer attached to the frame hitch of the vehicle.

### BACKGROUND OF THE INVENTION

Winches attached to vehicles are powerful tools used for various applications, such as off-road recovery, towing, and lifting heavy loads. These winches consist of a motorized drum, a steel cable or synthetic rope, and a control system. The winch is typically mounted to the front or rear of a vehicle, often on a specially designed bumper or attachment point. When engaged the winch uses its motor to wind the cable or rope around the drum, creating tension that allows the winch to pull or lift objects with great force. Winches offer significant benefits, providing a reliable and efficient means of overcoming obstacles, recovering vehicles, and handling heavy loads. They are designed to withstand challenging conditions and are available in different sizes and capacities to match specific requirements. Proper usage and safety precautions are vital when operating winches attached to vehicles to prevent accidents and ensure the well-being of individuals involved.

An objective of the present invention is to provide users with a device to help attach a winch directly to a bumper hitch of a vehicle. More specifically, the present invention intends to provide users with a device that can load cargo vehicles onto a trailer attached to the frame hitch of a vehicle. To accomplish this, a main support bar connects the external winch to the external vehicle hitch via a winch plate or cradle. Further, a plurality of vertical supports, fasteners and telescopic adjustments enable the present invention to connect to different length trailers and trucks. Thus, the present invention is a device that allows a winch to be connected directly to a bumper hitch of a vehicle.

### SUMMARY OF THE INVENTION

The winch connecting device is intended to provide users with a device that can load cargo vehicles onto a trailer that is attached to the frame hitch of a vehicle. More specifically, the present invention is a device that is attached to the bumper hitch ball of a vehicle. Further, the present invention seeks to provide users with a device that allows a winch to connect directly to a bumper hitch via a winch plate or cradle. In order to accomplish this, a preferred embodiment of the present invention comprises a plurality of support brackets, a telescopic main bar, a hitch ball receiver, and a winch receiver. Furthermore, present invention comprises a plurality of length adjusting holes and a plurality of fasteners. The main bar connects the external winch to the external vehicle hitch, and the hitch ball receiver connects to a hitch ball. Thus, the present invention is a device that allows a winch to be connected directly to a bumper hitch of a vehicle.

### BRIEF DESCRIPTION OF THE DRAWINGS

FIG. 1 is a top-front-left perspective view of the present invention.

FIG. 2 is a bottom-rear-left perspective view of the present invention, wherein a plurality of fasteners is connected.

FIG. 3 is a detailed view taken about circle 3 in FIG. 2.

FIG. 4 is a detailed view taken about circle 4 in FIG. 2.

FIG. 5 is a bottom-rear-right perspective view of the present invention.

FIG. 6 is a front elevational view of the present invention.

FIG. 7 is a rear elevational view of the present invention.

FIG. 8 is a top plan view of the present invention, wherein a plurality of fasteners is shown.

FIG. 9 is a left side elevational view of the present invention with a plurality of fasteners.

FIG. 10 is a left side elevational view of an alternate embodiment of the present invention, wherein additional telescopic segments are integrated along the main bar for providing extra length adjustments.

### DETAILED DESCRIPTION OF THE INVENTION

All illustrations of the drawings are for the purpose of describing selected versions of the present invention and are not intended to limit the scope of the present invention.

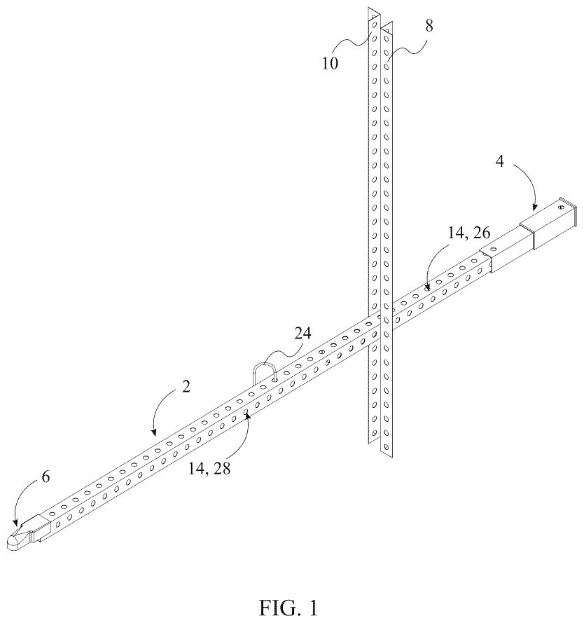

The following description is in reference to FIG. 1 through FIG. 10. According to a preferred embodiment, the present invention comprises a main bar 2, a winch receiver 4, a hitch ball receiver 6, a first support bracket 8, a second support bracket 10, a plurality of fasteners 12, and a plurality of length-adjusting holes 14. Preferably, the main bar 2 is a rectangular bar with a hollow square cross-section. In the preferred embodiment, the main bar 2 comprises a first bar end 16 and a second bar end 18, wherein the first bar end 16 is positioned opposite to the second bar end 18 along the main bar 2. In other words, the first bar end 16 constitutes a rear end of the of the main bar 2 and the second bar end 18 constitutes a front end of the main bar 2.

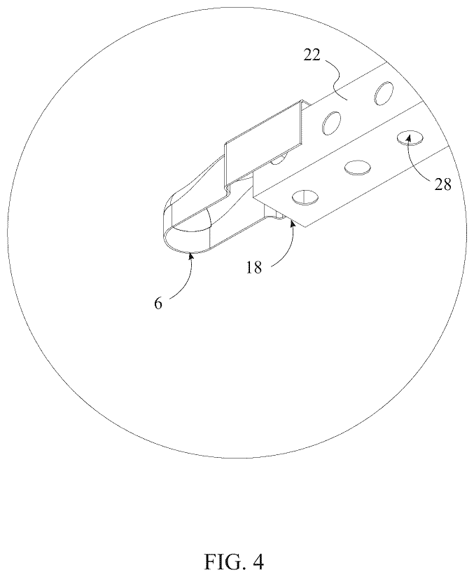

According to the preferred embodiment, the winch receiver 4 is mounted onto the first bar end 16, and the hitch ball receiver 6 is mounted onto the second bar end 18. The hitch ball receiver 6 is designed to secure to a bumper hitch ball with its unique oblong shape as shown in FIG. 4. Further, the winch receiver 4 is designed to connect the winch cradle along the terminal end of the main bar 2. With all the components working in tandem with each other, the present invention allows a winch to be connected directly to a bumper hitch of a vehicle.

In order to provide length adjustments between the trailer hitch ball and the winch connecting bumper hitch, the plurality of length-adjusting holes 14 is provided. As seen in FIG. 1 through FIG. 9, each of the plurality of length-adjusting holes 14 traverses perpendicular through the main bar 2, and the plurality of length-adjusting holes 14 is distributed along the main bar 2. Preferably, the plurality of length-adjusting holes 14 are circular shaped holes that help in attaching various pieces of the present invention, by threading the plurality of fasteners 12 through them.

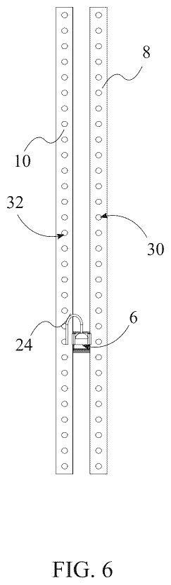

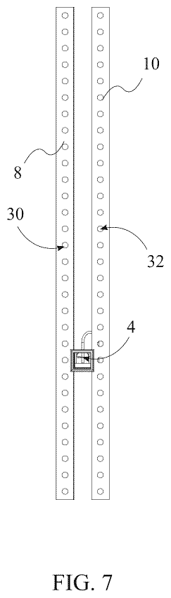

According to the preferred embodiment, the present invention is provided with vertical support via the plurality of support brackets. Accordingly, the first support bracket 8 is laterally mounted to the main bar 2, and the second support bracket 10 is laterally mounted to the main bar 2, opposite to the first support bracket 8. Further, as seen in FIG. 6 and FIG. 7, the first support bracket 8 and the second support bracket 10 are positioned parallel to each other. Furthermore, the plurality of fasteners 12 allows the support brackets to be connected to the main bar 2. In other words, the plurality of fasteners 12 is attached through the first support bracket 8, the second support bracket 10, and the main bar 2. Preferably, the plurality of fasteners 12 is a bolt and nut combination that secures the main bar 2 perpendicular to the support brackets. It should be further noted that the first support bracket 8 and the second support bracket 10 may be created in many various shapes and sizes and the plurality of fasteners 12 could be designed in various ways while still staying within the scope of the present invention.

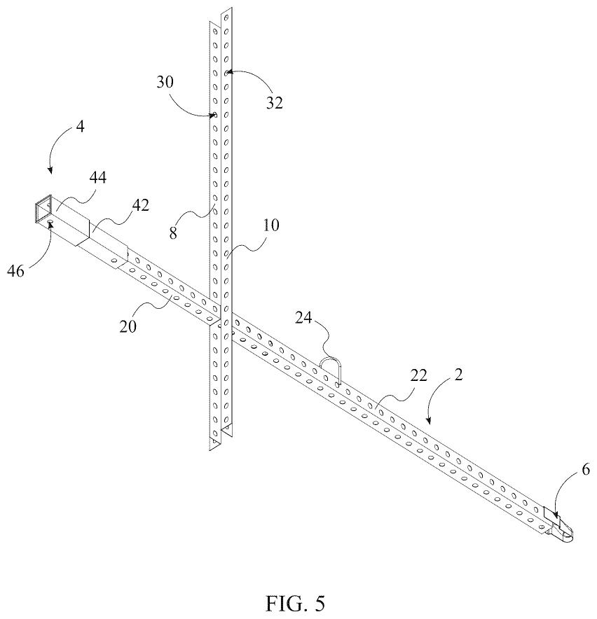

In order to provide length adjustments along the main bar 2, the main bar 2 may further comprise a first bar portion 20, a second bar portion 22, and a channel locking mechanism 24. In the preferred embodiment, the first bar portion 20 and the second bar portion 22 are telescopically engaged with each other. The second bar portion 22 is designed with a similar shape to the first bar portion 20, but with a slightly smaller cross-section that allows the second bar portion 22 to extend from the first bar portion 20 as seen in FIG. 5. In other words, the first bar portion 20 and the second bar portion 22 are a telescopic pair of rectangular tubes. As seen in FIG. 5, the winch receiver 4 is terminally mounted onto the first bar portion 20, offset from the second bar portion 22, and the hitch ball receiver 6 is terminally mounted onto the second bar portion 22, offset from the first bar portion 20.

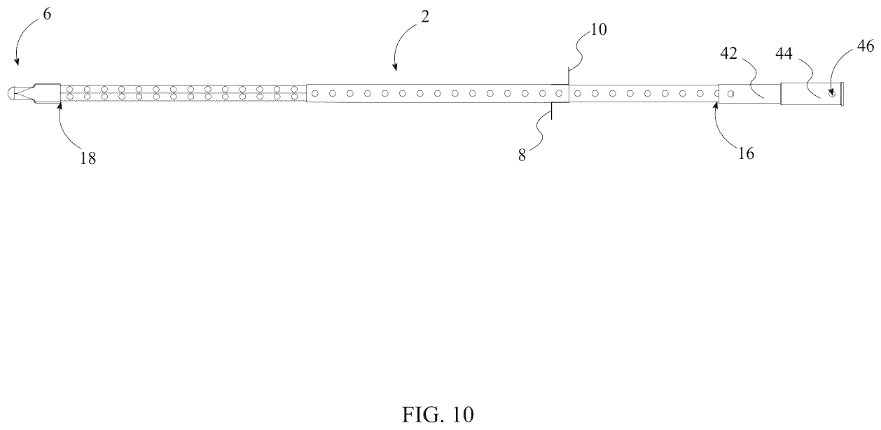

In an alternate embodiment, and as seen in FIG. 10, the main bar 2 may comprise additional telescopic segments or tubes that can help with length adjustments of the main bar 2. In other words, extra tubes and bolts may be integrated along the main bar 2, to extend the tubing for longer trailers. It should be noted that, any other number of telescopic segments and fasteners of different shapes, dimensions, and locations, will fall under the scope of the present invention, as long as the intents of the present invention are not altered.

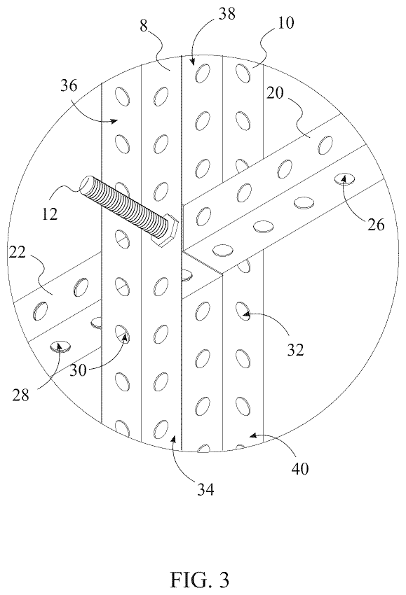

In the preferred embodiment, the plurality of length-adjusting holes 14 comprises a plurality of first length-adjusting holes 26 and a plurality of second length-adjusting holes 28. As seen in FIG. 3, each of the plurality of first length-adjusting holes 26 traverses perpendicular through the first bar portion 20, and the plurality of first length-adjusting holes 26 is distributed along the first bar portion 20. Similarly, each of the plurality of second length-adjusting holes 28 traverses perpendicular through the second bar portion 22, and the plurality of second length-adjusting holes 28 is distributed along the second bar portion 22. Further, in order to quickly lock the desired position of the first bar portion 20 and the second bar portion 22, the channel locking mechanism 24 is engaged to a selected first length-adjusting hole from the plurality of first length-adjusting holes 26 and a selected second length-adjusting hole from the plurality of second length-adjusting holes 28. As seen in FIG. 1, the channel locking mechanism 24 is a U-shaped rod. However, the channel locking mechanism 24 may comprise any other shape or fastening technology that is known to one of ordinary skill in the art, as long as the intents of the present invention are not altered.

Continuing with the preferred embodiment, the present invention comprises a plurality of first bracket holes 30 and a plurality of second bracket holes 32. Preferably, the plurality of first bracket holes 30 and the plurality of second bracket holes 32 help connect the first support bracket 8 and the second support bracket 10 respectively, to the main bar 2, with the help of the plurality of fasteners 12. As seen in FIG. 6 and FIG. 7, each of the plurality of first bracket holes 30 traverses perpendicular through the first support bracket 8, and the plurality of first bracket holes 30 is distributed along the first support bracket 8. Similarly, each of the plurality of second bracket holes 32 traverses perpendicular through the second support bracket 10, and the plurality of second bracket holes 32 is distributed along the second support bracket 10. Thus, in order to attach the support brackets to the main bar 2, the plurality of fasteners 12 is attached through at least two selected length-adjusting holes from the plurality of length-adjusting holes 14, at least two selected second bracket holes from the plurality of first bracket holes 30, and at least two selected second bracket holes from the plurality of second bracket holes 32.

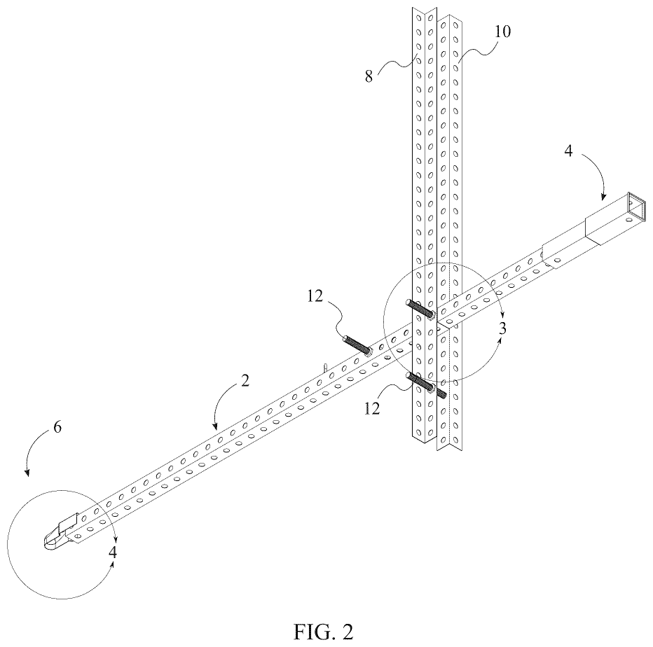

As seen in FIG. 2 and FIG. 5, the first support bracket 8 and the second support bracket 10 may be a pair of angle bars. More specifically, the first support bracket 8 may comprise a first proximal angle leg 34 and a first distal angle leg, wherein the first proximal angle leg 34 and the first distal angle leg 42 are connected perpendicular to each other. Further, the first proximal angle leg 34 is laterally positioned against the main bar 2, when the first support bracket 8 is connected to the main bar 2. Similarly, the second support bracket 10 may comprise a second proximal angle leg 38 and a second distal angle leg 40. This is so that the angle bars provide necessary support without taking too much space, weight, and hinderance while connecting the various pieces of the present invention. As seen in FIG. 3, the second proximal angle leg 38 and the second distal angle leg 40 are connected perpendicular to each other, and the second proximal angle leg 38 is laterally positioned against the main bar 2 when the second support bracket 10 is attached to the main bar 2.

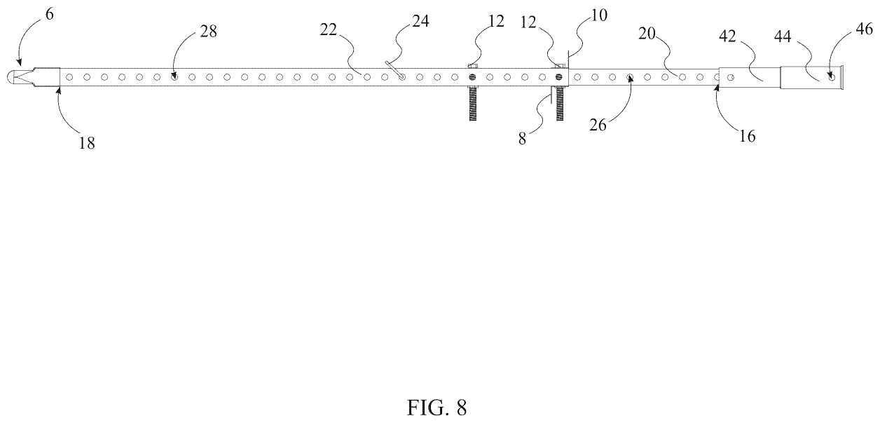

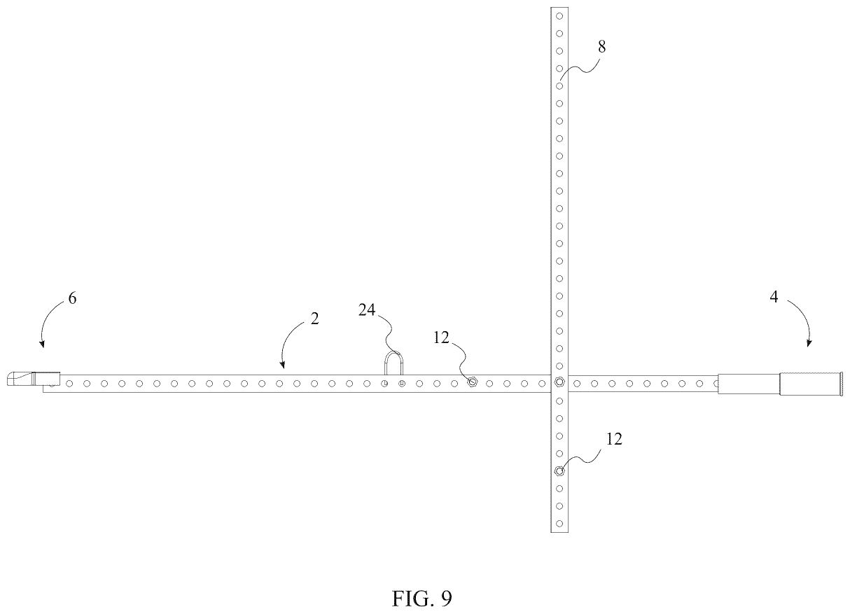

As seen in FIG. 8, the winch receiver 4 may comprise a narrow region 42, a wide region 44, and at least one receiving hole 46. The wide region 44 creates a larger cross section that allows for the present invention to receive an external object. As seen in FIG. 9, the narrow region 42 is connected to the main bar 2, and the at least one receiving hole 46 traverses laterally and perpendicularly through the wide region 44. Preferably, the at least one receiving hole 46 has a circular shape that allows the present invention to secure an object within the wide region 44 with a fastener. Thus, with all the components working in tandem with each other, the present invention allows a winch to be connected directly to a bumper hitch of a vehicle.

Although the invention has been explained in relation to its preferred embodiment, it is to be understood that many other possible modifications and variations can be made without departing from the spirit and scope of the invention as hereinafter claimed.

What is claimed is:

1. A winch connecting device comprising:
a main bar;
a winch receiver;
a hitch ball receiver;
a first support bracket;
a second support bracket;
a plurality of fasteners;
a plurality of length-adjusting holes;
the main bar comprising a first bar end and a second bar end;
the first bar end being positioned opposite to the second bar end along the main bar;
each of the plurality of length-adjusting holes traversing perpendicular through the main bar;
the plurality of length-adjusting holes being distributed along the main bar;
the winch receiver being mounted onto the first bar end;
the hitch ball receiver being mounted onto the second bar end;
the first support bracket being laterally mounted to the main bar;
the second support bracket being laterally mounted to the main bar, opposite to the first support bracket;
the first support bracket and the second support bracket being positioned parallel to each other; and
the plurality of fasteners being attached through the first support bracket, the second support bracket, and the main bar.

2. The winch connecting device of claim 1 comprising:
the main bar further comprising a first bar portion, a second bar portion, and a channel locking mechanism;
the plurality of length-adjusting holes comprising a plurality of first length-adjusting holes and a plurality of second length-adjusting holes;
each of the plurality of first length-adjusting holes traversing perpendicular through the first bar portion;
the plurality of first length-adjusting holes being distributed along the first bar portion;
each of the plurality of second length-adjusting holes traversing perpendicular through the second bar portion;
the plurality of second length-adjusting holes being distributed along the second bar portion;
the first bar portion and the second bar portion being telescopically engaged with each other; and
the channel locking mechanism being engaged to a selected first length-adjusting hole from the plurality of first length-adjusting holes and a selected second length-adjusting hole from the plurality of second length-adjusting holes.

3. The winch connecting device of claim 2, wherein the channel locking mechanism is a U-shaped rod.

4. The winch connecting device of claim 2, wherein the winch receiver is terminally mounted onto the first bar portion, offset from the second bar portion.

5. The winch connecting device of claim 2, wherein the hitch ball receiver is terminally mounted onto the second bar portion, offset from the first bar portion.

6. The winch connecting device of claim 2, wherein the first bar portion and the second bar portion are a telescopic pair of rectangular tubes.

7. The winch connecting device of claim 1 further comprising:
a plurality of first bracket holes;
a plurality of second bracket holes;
each of the plurality of first bracket holes traversing perpendicular through the first support bracket;
the plurality of first bracket holes being distributed along the first support bracket;
each of the plurality of second bracket holes traversing perpendicular through the second support bracket; and
the plurality of second bracket holes being distributed along the second support bracket.

8. The winch connecting device of claim 7 further comprising:
the plurality of fasteners being attached through at least two selected length-adjusting holes from the plurality of length-adjusting holes, at least two selected second bracket holes from the plurality of first bracket holes, and at least two selected second bracket holes from the plurality of second bracket holes.

9. The winch connecting device of claim 1 comprising:
the first support bracket and the second support bracket being a pair of angle bars;
the first support bracket comprising a first proximal angle leg and a first distal angle leg;
the second support bracket comprising a second proximal angle leg and a second distal angle leg;
the first proximal angle leg and the first distal angle leg being connected perpendicular to each other;
the first proximal angle leg being laterally positioned against the main bar;
the second proximal angle leg and the second distal angle leg being connected perpendicular to each other; and
the second proximal angle leg being laterally positioned against the main bar.

10. The winch connecting device of claim 1 further comprising:
the winch receiver comprising a narrow region, a wide region, and at least one receiving hole;
the narrow region being connected to the main bar; and
the at least one receiving hole traversing laterally and perpendicularly through the wide region.

11. A winch connecting device comprising:
a main bar;
a winch receiver;
a hitch ball receiver;
a first support bracket;
a second support bracket;
a plurality of fasteners;
a plurality of length-adjusting holes;
the main bar comprising a first bar end, a second bar end, a first bar portion, and a second bar portion;
the first bar end being positioned opposite to the second bar end along the main bar;
the first bar portion and the second bar portion being telescopically engaged with each other;
each of the plurality of length-adjusting holes traversing perpendicular through the main bar;
the plurality of length-adjusting holes being distributed along the main bar;
the winch receiver being mounted onto the first bar end;
the hitch ball receiver being mounted onto the second bar end;
the first support bracket being laterally mounted to the main bar;
the second support bracket being laterally mounted to the main bar, opposite to the first support bracket;
the first support bracket and the second support bracket being positioned parallel to each other; and
the plurality of fasteners being attached through the first support bracket, the second support bracket, and the main bar.

12. The winch connecting device of claim 11, wherein the winch receiver is terminally mounted onto the first bar portion, offset from the second bar portion.

13. The winch connecting device of claim 11, wherein the hitch ball receiver is terminally mounted onto the second bar portion, offset from the first bar portion.

14. The winch connecting device of claim 11, wherein the first bar portion and the second bar portion are a telescopic pair of rectangular tubes.

15. The winch connecting device of claim 11 comprising:
the main bar further comprising a channel locking mechanism;
the plurality of length-adjusting holes comprising a plurality of first length-adjusting holes and a plurality of second length-adjusting holes;
each of the plurality of first length-adjusting holes traversing perpendicular through the first bar portion;
the plurality of first length-adjusting holes being distributed along the first bar portion;
each of the plurality of second length-adjusting holes traversing perpendicular through the second bar portion;
the plurality of second length-adjusting holes being distributed along the second bar portion;
the first bar portion and the second bar portion being telescopically engaged with each other; and
the channel locking mechanism being engaged to a selected first length-adjusting hole from the plurality of first length-adjusting holes and a selected second length-adjusting hole from the plurality of second length-adjusting holes.

16. The winch connecting device of claim 11 further comprising:
a plurality of first bracket holes;
a plurality of second bracket holes;
each of the plurality of first bracket holes traversing perpendicular through the first support bracket;
the plurality of first bracket holes being distributed along the first support bracket;
each of the plurality of second bracket holes traversing perpendicular through the second support bracket; and
the plurality of second bracket holes being distributed along the second support bracket.

17. The winch connecting device of claim 16 further comprising:
the plurality of fasteners being attached through at least two selected length-adjusting holes from the plurality of length-adjusting holes, at least two selected second bracket holes from the plurality of first bracket holes, and at least two selected second bracket holes from the plurality of second bracket holes.

18. The winch connecting device of claim 11 wherein the first support bracket and the second support bracket being a pair of angle bars;

19. The winch connecting device of claim 11 further comprising:
the winch receiver comprising a narrow region, a wide region, and at least one receiving hole;
the narrow region being connected to the main bar; and
the at least one receiving hole traversing laterally and perpendicularly through the wide region.
